(19) United States
(12) Patent Application Publication
(10) Pub. No.: US 2009/0155697 A1
(43) Pub. Date: Jun. 18, 2009

(54) Electrolyte for lithium secondary battery and lithium secondary battery comprising the same

(75) Inventors: Na-Rae PARK, Suwon-si (KR); Jin-Bum Kim, Suwon-si (KR); Jin-Sung Kim, Suwon-si (KR); Jin-Hyunk Lim, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/328,134

(22) Filed: Dec. 4, 2008

(30) Foreign Application Priority Data
Dec. 14, 2007 (KR) 2007-130809

(51) Int. Cl. H01M 6/16

(52) U.S. Cl. 429/339; 429/342; 429/212

(57) ABSTRACT

An electrolyte for a lithium battery includes a non-aqueous organic solvent; a lithium salt; a first additive, which is 2-sulfobenzoic acid cyclic anhydride, represented by Formula 1 below, and a second additive, which is a carbonate derivative having a substituent selected from the group consisting of halogen, a cyano (CN) group and a nitro (NO₂) group.

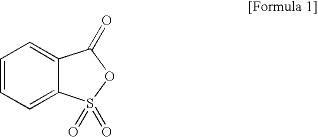

A lithium secondary battery containing the electrolyte is excellent in terms of its battery life and low-temperature discharge capacity characteristics, and t has a reduced expansion at room temperature or at high temperatures.

### CROSS-REFERENCE TO RELATED APPLICATION

This application claims the benefit of Korean Application No. 2007-130809, filed Dec. 14, 2007, in the Korean Intellectual Property Office, the disclosure of which is incorporated herein by reference.

### BACKGROUND OF THE INVENTION

1. Field of the Invention

Aspects of the present invention relate to an electrolyte for a lithium secondary battery and a lithium secondary battery comprising the same, and more particularly, to an electrolyte for a lithium secondary battery and a lithium secondary battery comprising the same that provides a decreased thickness expansion coefficient at room temperature and at high temperatures and that has excellent characteristics in terms of the life and low-temperature discharge capacity.

2. Description of the Related Art

As electronic equipment has been smaller and lighter due to the development of high-tech electronics industries, the use of portable electronic products has been increasing. Accordingly, batteries having a high energy density are increasingly desirable as sources of electricity for the portable electronic products, and research relating to lithium secondary batteries has been actively conducted. In typical lithium secondary batteries, lithium-transition metal oxides are used as positive electrode active materials, and carbon (crystal or amorphous carbon) or carbon mixtures are used as negative electrode active materials. To manufacture a square secondary battery, an electrode assembly is formed by coating respective current collectors with respective active substances at a proper thickness and length or coating respective current collectors with respective active substances in the form of a film and respectively winding/laminating the current collectors about/on either side of a separator, which is an insulator. The formed electrode assembly is put into a can or a case and an electrolyte is injected into the can.

Lithium has the largest electric capacity per unit mass because it is the lightest metal among the metals existing on earth. Lithium is a desirable material for use in batteries having high voltages because lithium, being the lightest metal, has a large electric capacity per unit mass and because lithium has high thermodynamic oxidation potential. Therefore, lithium is an active substance that is desired for batteries to generate maximum energy using a limited quantity of a chemical substance, specifically, for secondary batteries.

A lithium ion secondary battery comprises a positive electrode active material using lithium metal mixed oxides that enable the deintercalation and intercalation of lithium ions, a negative electrode active material comprising carbon materials or metal lithium and the like, and an electrolyte obtained by dissolving an appropriate amount of a lithium electrolytic salt in an organic mixed solvent. The energy density of a lithium ion secondary battery is about 200% higher than that of a nickel cadmium (Ni—Cd) battery and is about 160% higher than that of a nickel metal hydride (Ni-MH) battery. The energy density of a lithium ion secondary battery per unit mass is about 170% higher than that of the Ni—Cd battery and is about 105% higher than that of the Ni-MH battery. The self-discharge rate of a lithium ion secondary battery is less than about 5% per month at 20° C., which is about ⅓ lower than that of the Ni—Cd battery or Ni-MH battery. A lithium ion secondary battery is friendly to the environment because it does not use any heavy metals, such as cadmium or mercury, that may pollute the environment. A lithium ion secondary battery has a long life span in that the battery is capable of undergoing repeating charging/discharging more than 500 times under normal conditions.

Furthermore, a lithium ion secondary battery generally has an average discharging voltage of 3.6 to 3.7V. The average discharging voltage of 3.6 to 3.7V of the lithium ion secondary battery is a great advantage for producing high electric power, compared to another alkali battery, Ni-MH battery or Ni—Cd battery.

To produce the high driving voltage, however, it is desirable to provide an electrolyte that is electrochemically stable at a charging/discharging voltage range of 2.75 to 4.2V of the lithium ion battery. The desired stability may be obtained by using non-aqueous mixed solvents that comprise combinations of carbonates, such as ethylene carbonate (EC), propylene carbonate (PC), dimethyl carbonate (DMC), ethylmethyl carbonate (EMC), diethyl carbonate (DEC) and the like.

However, an electrolyte such as the aforementioned composition may be disadvantageous for high rate charging/discharging because the ion conductivity may be remarkably lower than an aqueous electrolyte used in an Ni-MH battery or Ni—Cd battery.

For example, ethylene carbonate (EC) has a drawback in performance at low temperature because its freezing point is 36° C. Propylene carbonate (PC) has the drawback in that, upon charging/discharging, it decomposes in artificial graphite, which is commonly used as a negative electrode. Dimethyl carbonate (DMC) with a freezing point of about 3° C. and a boiling point of about 90° C. has poor performance at low temperatures, like ethylene carbonate (EC), and, has a poor high-temperature resistance. Diethyl carbonate (DEC) has excellent performance, with a freezing point below −40° C. and a boiling point of about 126° C., but has a low mixability with other solvents. Ethylmethyl carbonate (EMC), with a freezing point below −30° C. and a boiling point of about 107° C., is most used for a mixture but has performance in terms of temperature.

As described above, the commonly used non-aqueous solvents have their respective advantages and drawbacks. Therefore, the performance of a battery varies greatly depending on the combinations of solvents that are actually used. Therefore, battery industries have steadily conducted tests to find combinations having improved performance. Currently, EC/DMC/EMC, EC/EMC/DEC, EC/DMC/EMC/PC and the like are commonly used.

Furthermore, the characteristics of a lithium secondary battery are affected by the particular electrolytic salts used. For example, LiPF₆, LiBF₄, LiClO₄, LiN(SO₂CF₃)₂ and LiN(SO₂CF₂CF₃)₂ are commonly used as solutes for the electrolyte of a lithium secondary battery. These materials act as sources of lithium ions in a battery cell, thereby enabling the basic operation of the lithium secondary battery. In general, among the electrolytic salts, LiBF₄ is regarded as being most excellent in terms of thermal stability at high temperature.

The electrolyte of a lithium ion battery, comprising a carbonate-based organic solvent and an electrolytic salt, reacts with carbon contained in the negative electrode and forms a thin film called a solid electrolyte interface (SEI) on the surface of the negative electrode. The SEI film is a major factor causing a change in the performance of a battery by affecting the movement of ions and electric charges.

However, during the reaction that forms the SEI film, gases such as CO, CO₂, CH₄, C₂H₆ and the like are generated as the carbonate-based organic solvent decomposes. Due to these gases, the battery expands in thickness during charging. Moreover, if a fully charged battery is stored at a high temperature (for example, if a battery that is 100% charged at 4.2V is left at 85° C. for 4 days), the SEI film slowly breaks down as a result of electrochemical energy and thermal energy, which increases as time goes by, and the electrolyte around the SEI film continuously participates in side reactions by reacting with the newly exposed surface of the negative electrode. Then, CO, CO₂, CH₄, C₂H₆ and the like, are generated according to the kinds of carbonates in the solvent and type of negative electrode active material. As a result, the continuous generation of gases increases the internal pressure of the battery.

Much research has been steadily conducted to improve the physical and chemical characteristics of the SEI film to overcome the above-mentioned problems, by changing the reaction upon the SEI film formation by adding additives to the electrolyte that have excellent performance. However, research to date has not completely solved the problems relating to the formation of the SEI film in a lithium ion battery at high temperature. Moreover, when specific additives are added to the electrolyte, it has been found that the performance of some characteristics of the battery may improve but the performance of the other characteristics may decrease.

### SUMMARY OF THE INVENTION

Therefore, aspects of the present invention are directed to providing an electrolyte for a lithium secondary battery and a lithium secondary battery comprising the same in which a thickness expansion coefficient at room temperature and high temperature is decreased and that has excellent characteristics in terms of the life and low-temperature discharge capacity.

In accordance with embodiments of the present invention, there is provided an electrolyte for a lithium secondary battery and a lithium secondary battery using the same, in which the electrolyte comprises a non-aqueous organic solvent; a lithium salt; a first additive, which is 2-sulfobenzoic acid cyclic anhydride, represented by Formula 1 below, and a second additive, which is a carbonate derivative having a substituent selected from the group consisting of halogen, a cyano (CN) group and a nitro (NO₂) group.

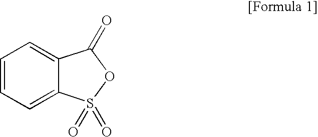

According to an aspect of the present invention, the amount of the first additive may be 0.1 to 5 wt % of the electrolyte.

According to another aspect of the present invention, the amount of the second additive may be 0.1 to 10 wt % of the electrolyte.

According to another aspect of the present invention, the second additive may be fluoroethylene carbonate.

According to another aspect of the present invention, there is also provided a method of inhibiting a breakdown of a solid electrolyte interface (SEI) film and a decomposition of a carbonate-based solvent of an electrolyte in a lithium secondary battery, the method comprising including, as additives in the electrolyte, 0.1 to 5 wt % of 2-sulfobenzoic acid cyclic anhydride and 0.1 to 10 wt % of a carbonate derivative having a substituent selected from the group consisting of halogen, a cyano (CN) group and a nitro (NO₂) group.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a graph illustrating a change in a state of charge with respect to the number of charging/discharging cycles of lithium ion batteries according to Exemplary Embodiments 1, 2, 3 and 4 and Comparative Example 1; and

FIG. 2 is a graph illustrating a change in capacity, with respect to the number of charging/discharging cycles of lithium ion batteries according to Exemplary Embodiment 2 and Comparative Examples 4 and 6.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention relate to a lithium secondary battery in which a thickness expansion coefficient at room temperature and high temperature is decreased and in which the performance of the battery is improved by adding, to an electrolyte containing a non-aqueous organic solvent and a lithium salt, 2-sulfobenzoic acid cyclic anhydride (SBACA), which is the compound represented by Formula 1 below, and a carbonate derivative having substituent selected from the group consisting of halogen, a cyano (CN) group and a nitro (NO₂) group as additives.

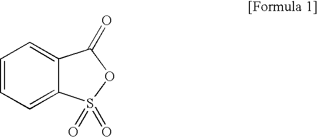

The lithium secondary battery comprising the electrolyte according to an embodiment of the present invention will be described below:

The electrolyte according to an embodiment of the present invention comprises a non-aqueous organic solvent. Carbonates, esters, ethers or ketones may be used as the non-aqueous organic solvent. Examples of the carbonates include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC) and the like. Examples of the esters include butyrolactone (BL), decanolide, valerolactone, mevalonolactone, caprolactone, n-methyl acetate, n-ethyl acetate, n-propyl acetate and the like. As an ether, dibutyl ether and the like may be used. As a ketone, polymethylvinyl ketone may be used. However, the present invention is not limited to the particular kind of non-aqueous organic solvent.

When the non-aqueous organic solvent is based on carbonates, as a specific, non-limiting example, a mixture of a cyclic carbonate and a chain carbonate may be used. In this case, the volume ratio of the cyclic carbonate to the chain carbonate in the mixture may be 1:1 to 1:9, or more specifically, 1:1.5 to 1:4. When the mixture is formed based on the above-defined volume ratio, the electrolyte has better performance.

The electrolyte may further comprise an aromatic hydrocarbon-based organic solvent in the carbonate-based solvent. An aromatic hydrocarbon-based compound may be used as the aromatic hydrocarbon-based organic solvent.

Specific examples of the aromatic hydrocarbon-based organic solvent include benzene, fluorobenzene, chlorobenzene, nitrobenzene, toluene, fluorotoluene, trifluorotoluene, xylene and the like. In the electrolyte including the aromatic hydrocarbon-based organic solvent, as a non-limiting example, the volume ratio of the carbonate-based solvent to the aromatic hydrocarbon-based organic solvent may be 1:1 to 30:1. When the carbonate-based solvent and the aromatic hydrocarbon-based organic solvent are mixed at the above-defined volume ratio, the electrolyte has better performance.

The electrolyte further comprises a lithium salt. The lithium salt acts as the source of lithium ions inside the battery, thereby enabling the basic operation of the lithium battery. Examples of the lithium salt include one or more selected from the group consisting of LiPF₆, LiBF₄, LiSbF₆, LiAsF₆, LiClO₄, LiCF₃SO₃, LiN(CF₃SO₂)₂, LiN(C₂F₅SO₂)₂, LiAlO₄, LiAlCl₄, LiN(CₓF₂ₓ₊₁SO₂)(C_{y}F₂ₓ₊₁SO₂) (wherein, x and y are natural numbers) and LiSO₃CF₃.

The density of the lithium salt in the electrolyte may be within the range of 0.6 to 2.0M, or more specifically within the range of 0.7 to 1.6M. When the density of the lithium salt is less than 0.6M, the viscosity of the electrolyte may be too low so that the performance of the electrolyte may deteriorate. When the density of the lithium salt is in excess of 2.0M, the viscosity of the electrolyte increases so that the mobility of lithium ions decreases.

The electrolyte further comprises, as an additive, 2-sulfobenzoic acid cyclic anhydride, which is the compound represented by Formula 1 below:

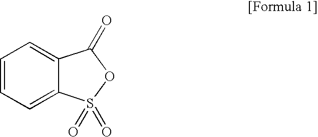

According to aspects of the present invention, the additive is used to decrease the thickness expansion of the battery at room temperature and high temperature by controlling a decomposition reaction of the solvent due to the decomposition of a solid electrolyte interface (SEI) film when the battery is stored at a high temperature.

The SEI film is formed on the surface of a negative electrode when carbon that makes up the negative electrode reacts with the electrolyte. The SEI film will be described, in more detail, below: When the lithium ion battery is first charged, the lithium ions from a lithium metal oxide used as a positive electrode move to a carbon (which is crystal or amorphous) electrode used as the negative electrode and are intercalated into the carbon of the negative electrode. Then, lithium with strong reactivity reacts with the carbon negative electrode, thereby forming Li₂CO₃, Li₂O, LiOH and the like. These oxides form the SEI film on the surface of the negative electrode.

After the SEI film is formed at the first charge, the SEI film prevents the reaction of lithium ions with the carbon negative electrode or other substances when the battery is repeatedly charged and/or discharged due to its use. That is, the SEI film performs the function of an ion tunnel allowing only lithium ions to pass through between the electrolyte and the negative electrode.

Based on the ion tunnel effect, the SEI film prevents the organic solvents of the electrolyte having large molecular weight, such as, for example, EC, DMC, DEC and the like, from moving to the carbon negative electrode. As a result, the SEI film prevents the structure of the carbon negative electrode from being broken by the organic solvents and by the lithium ions that are co-intercalated into the carbon negative electrode. Once the SEI film is formed, since lithium ions do not again participate in side reactions with the carbon negative electrode or other substances, the amount of the lithium ions available for electrochemical reactions is reversibly maintained when charging/discharging by use of the battery.

In other words, since the carbon material of the negative electrode forms a passivation layer on the surface of the negative electrode by reacting with the electrolyte at the time of the first charging, additional decomposition of the electrolyte does not occur, so that stable charging/discharging can be maintained. Then, since the electric charge that is consumed to form the passivation layer on the surface of the negative electrode has a non-reversible capacity, that the passivation layer does not reversibly react when the battery is discharged. Therefore, the lithium ion battery does not reversibly react further after the reaction at the time of the first charging and the lithium ion battery thereafter maintains a stable life cycle.

However, when a fully charged lithium ion battery is stored at high temperature (such as, for example, when the lithium ion battery is left at 85° C. for 4 days, at a 100% charge level), it has a drawback that the SEI film slowly breaks down from the additional electrochemical energy and thermal energy, which increase as time goes by. Then, the carbonate-based solvent of the electrolyte around the SEI film reacts with the exposed surface of the negative electrode as the SEI film breaks down, thereby continuously causing a side reaction that decomposes the carbonate-based solvent.

The side reaction continuously generates gases such as CO, CO₂, CH₄, C₂H₆ and the like. The particular gases that are generated depend on the particular kinds of carbonates and negative electrode active materials present in the battery. Irrespective of the kinds thereof, the continuous generation of the gases increases the internal pressure of the lithium ion battery at high temperature so that the thickness of the battery expands.

However, according to aspects of the present invention, 2-sulfobenzoic acid cyclic anhydride is added to the electrolyte. 2-sulfobenzoic acid cyclic anhydride accelerates the forming of the SEI film at the first charging, compared with the conventional carbonate-based organic solvent, and controls the decomposition of the carbonate-based organic solvent. Consequently, the electrolyte according to aspects of the present invention controls the expansion of the lithium ion battery when the battery is charged at room temperature and when the battery is stored at a high temperature at the full charge level.

That is, 2-sulfobenzoic acid cyclic anhydride decomposes earlier than the carbonate-based organic solvent, and at that voltage, the SEI reaction occurs. Then, since the formed SEI film prevents the deposition of the carbonate-based organic solvent, such as EC, DMC and the like, the SEI film controls the generation of the gases that would be caused by the decomposition of the carbonate-based organic solvent at the first charge and accordingly controls the expansion of the battery.

As a non-limiting example, the amount of the 2-sulfobenzoic acid cyclic anhydride to be added to the electrolyte may be 0.1 to 5.0 wt % of the electrolyte.

When the amount of 2-sulfobenzoic acid cyclic anhydride added to the electrolyte is less than 0.1 wt %, the effect to decrease the thickness increase rate may be minimal. When the amount of 2-sulfobenzoic acid cyclic anhydride is more than 5.0 wt %, there also may be no effect to decrease the thickness increase rate.

The electrolyte may also contain another additive, a carbonate derivative having a substituent selected from the group consisting of halogen, a cyano (CN) group and a nitro (NO₂) group. When the carbonate derivative is added to the electrolyte, the lithium ion battery has excellent electrochemical characteristics in terms of avoidance of high-temperature swelling, battery capacity, battery life and low-temperature performance. As a non-limiting example, an ethylene carbonate derivative represented by Formula 2 below may be used as the additive or more specifically, fluoroethylene carbonate may be used as the additive.

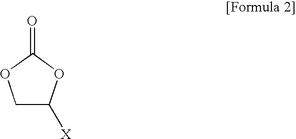

wherein X is selected from the group consisting of halogen, a cyano (CN) group and a nitro (NO₂) group.

The carbonate derivative is added in the amount of 0.1 to 10 wt % of the electrolyte. When the amount of the carbonate derivative is less than 0.1 wt %, the characteristics of battery life and low-temperature discharge of lithium ion battery may not be improved. When the amount of the carbonate derivative is more than 10 wt %, the lithium ion battery may swell at high temperatures.

A lithium ion battery comprising the electrolyte described above comprises a positive electrode and a negative electrode.

The positive electrode comprises a positive electrode active material that is capable of reversibly intercalating or deintercalating lithium ions. Typically, the positive electrode active material may include lithium-transition metal oxides, such as, for example, LiCoO₂, LiNiO₂, LiMnO₂, LiMn₂O₄ or LiNi_{1-x-y}COₓM_{y}O₂, wherein 0≦x≦1, 0≦y≦1, 0≦x+y≦1, and M is a metal such as Al, Sr, Mg or La and the like. The positive electrode active material for the positive electrode is not limited to these materials.

The negative electrode comprises a negative electrode active material that intercalates and deintercalates lithium ions. The negative electrode active material may be a carbon-based negative electrode active material, such as crystal carbon, amorphous carbon, carbon compounds and the like. The negative electrode active material for the negative electrode is not limited to these materials.

Each of the positive electrode active material and the negative electrode active material may be applied to a respective current collector as a thin film, in an appropriate thickness and length. The current collectors each coated with the respective positive/negative electrode active material are wound about or laminated on respective sides of a separator to form an electrode assembly. The separator may comprise a resin, such as polyethylene, polypropylene and the like. The electrode assembly is inserted into a can or a case. Thereafter, the electrolyte according to aspects of the present invention is injected into the can or case, thereby manufacturing the lithium secondary battery.

Below, embodiments according to aspects of the present invention and comparative examples will be described. However, the present invention may be embodied in many different forms and should not be construed as being limited to the embodiments set forth herein. Rather, these embodiments are provided so that this disclosure will be thorough and complete, and will fully convey the scope of the invention to those skilled in the art.

### Exemplary Embodiment 1

LiCoO₂ was used as the positive electrode active material, polyvinylidene fluoride (PVDF) was used as a binder, and carbon was used as a conductive material. After LiCoO₂, PVDF and carbon were mixed at a weight ratio of 92:4:4, the mixture was dispersed using N-methyl-2-pyrrolidone to form positive electrode slurry. Aluminum foil, 20 μm in thickness, was coated with the positive electrode slurry, and then dried and rolled to form the positive electrode. Crystal artificial graphite was used as the negative electrode active materials and PVDF was used as a binder. After the crystal artificial graphite and the PVDF were mixed at a weight ratio of 92:8, the mixture was dispersed using N-methyl-2-pyrrolidone to form negative electrode slurry. Copper foil, 15 μm in thickness, was coated with the negative electrode slurry, dried and rolled to form the negative electrode.

A 25 μm thick film separator composed of polyethylene (PE)was interposed between the electrodes as formed. The positive electrode, negative electrode and separator were wound and pressed together and put into a square can having the dimensions 30 mm×48 mm×6 mm.

An electrolyte was formed by adding 3.0 wt % fluoroethylene carbonate (FEC) to a solvent composed of ethylene carbonate/ethylmethyl carbonate/diethyl carbonate having a weight ratio of 1:1:1 and LiPF₆ at a density of 1.0 M. Then, 0.5 wt % 2-sulfobenzoic acid cyclic anhydride (SBACA) was added to the electrolyte. The lithium ion battery was manufactured by injecting the electrolyte into the square can.

### Exemplary Embodiment 2

Exemplary Embodiment 2 was carried out in the same manner as Exemplary Embodiment 1, except that 2-sulfobenzoic acid cyclic anhydride (SBACA) was added in an amount of 1 wt %.

### Exemplary Embodiment 3

Exemplary Embodiment 3 was carried out in the same manner as Exemplary Embodiment 1, except that 2-sulfobenzoic acid cyclic anhydride (SBACA) was added in an amount of 2 wt %.

### Exemplary Embodiment 4

Exemplary Embodiment 4 was carried out in the same manner as Exemplary Embodiment 1, except that 2-sulfobenzoic acid cyclic anhydride (SBACA) was added in an amount of 5 wt %.

### COMPARATIVE EXAMPLE 1

Comparative Example 1 was carried out in the same manner as Exemplary Embodiment 1, except that 2-sulfobenzoic acid cyclic anhydride (SBACA) was not added.

### COMPARATIVE EXAMPLE 2

Comparative Example 2 was carried out in the same manner as Exemplary Embodiment 1, except that 2-sulfobenzoic acid cyclic anhydride (SBACA) was added in an amount of 6 wt %.

After the lithium ion batteries of Exemplary Embodiment 1 to 4 and those of Comparative Examples 1 and 2 were charged under the charging conditions of constant current/constant voltage (CC-CV) at a charging voltage of 4.2 V and at an electric current of 170 mA, the lithium batteries were left for 1 hour, discharged to 2.75 V at an electric current of 170 mA, and left for 1 hour. After this process was performed 3 times, the lithium ion batteries were charged at a charging voltage of 4.2 V and at an electric current of 425 mA, for 2 hours and 30 minutes. A change in the thickness of each battery after being initially assembled and after being fully charged was measured. Further, after each battery was left in a chamber of 85° C. for 5 hours, an increase rate in the thickness of the battery at high temperature was measured.

Table 1 shows the results of these measurements.

TABLE 1

| | | | Change rate in | Change rate |
|---|---|---|---|---|
| | | | in thickness | in thickness |
| | | | of battery | of battery |
| | FEC | SBACA | being | being left at |
| | (wt %) | (wt %) | fully charged | high temperature |
| Exemplary | 3 | 0.5 | 4.5 | 10.0 |
| Embodiment 1 | | | | |
| Exemplary | 3 | 1 | 4.4 | 5.1 |
| Embodiment 2 | | | | |
| Exemplary | 3 | 2 | 4.1 | 4.8 |
| Embodiment 3 | | | | |
| Exemplary | 3 | 5 | 6.0 | 8.0 |
| Embodiment 4 | | | | |
| Comparative | 3 | 0 | 7.9 | 22.0 |
| Example 1 | | | | |
| Comparative | 3 | 6 | 8.0 | 17.5 |
| Example 2 | | | | |

From the results shown in Table 1, in Comparative Example 1 where the electrolyte does not contain SBACA, the change rate in the thickness of the battery after being fully charged increased by 7.9 %, compared to the thickness of the battery being initially assembled. However, in Exemplary Embodiments 1 to 4, the change rate in the thickness of each battery after being fully charged ranged from 4.1 to 6.0%, indicating that the change rate in the thickness of each battery was smaller than that of Comparative Example 1. Additionally, in Comparative Example 1, the change rate in the thickness of the battery being left at high temperature was 22.0%. However, in Exemplary Embodiments 1 to 4, the change rate in the thickness of each battery being left at high temperature was 10.0% or less, indicating that the change rate in the thickness of each battery being left at high temperature significantly decreased.

Furthermore, when SBACA was used in the amount of 6 wt %, that is, in excess of 5 wt %, the change rate in the thickness of the battery left at a high temperature was decreased compared with Comparative Example 1, where SBACA is not used, but the change rate in the thickness of the battery after being fully charged was higher.

Therefore, according to aspects of the present invention, when the amount of 2-sulfobenzoic acid cyclic anhydride (SBACA) is within the range of 0.1 to 5 wt %, compared to total 100 wt % of the electrolyte, the change rate in the thickness of the battery after being fully charged and the change rate in the thickness of the battery after being left at a high temperature are improved accordingly.

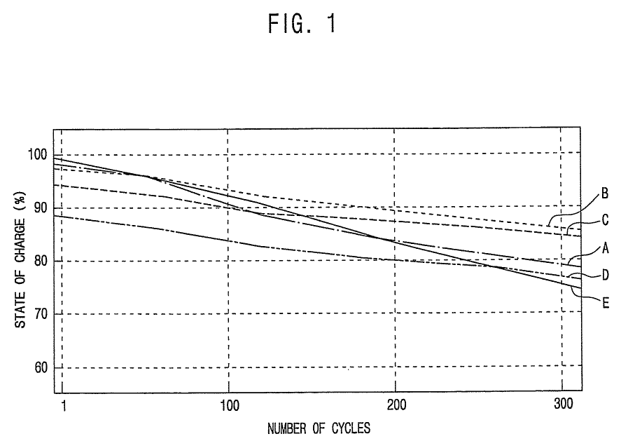

Further, after the lithium ion batteries of Exemplary Embodiments 1 to 4 and those of Comparative Examples 1 and 2 were charged under the conditions of CC-CV at a charging voltage of 4.2 V and at an electric current of 800 mA, for 2 hours and 30 minutes, the batteries were discharged at 2.75V cut-off and at an electric current of 800 mA. After this process is performed 300 times, a state of charge (%) of each battery was measured and compared with the initial capacity of the battery. The results of the measurement are shown in FIG. 1, which illustrates a change in the state of charge, depending on charging/discharging cycles.

In FIG. 1, lines A, B, C, D and E represent the state of charge with respect to the charging/discharging cycles of the batteries of Exemplary Embodiments 1, 2, 3 and 4 and Comparative Example 1, respectively. In Comparative Example 1 (line E), although the initial capacity was high, after the charging/discharging cycles were carried out 300 times, the state of charge was lower than that of Exemplary Embodiments 1, 2, 3 and 4 (lines A, B, C and D). These results demonstrate that the battery life of the battery of Comparative Example 1 was not as good as that of the batteries of Exemplary Embodiments 1, 2, 3 and 4.

Next, the characteristics of the lithium ion battery depending on the amount of 2-sulfobenzoic acid cyclic anhydride (SBACA) and the amount of fluoroethylene carbonate (FEC) will be compared below:

### Exemplary Embodiment 5

LiCoO₂ was used as the positive electrode active material, polyvinylidene fluoride (PVDF) was used as a binder, and carbon was used as a conductive material. After LiCoO₂, PVDF and carbon were mixed at a weight ratio of 92:4:4, the mixture was dispersed using N-methyl-2-pyrrolidone to form a positive electrode slurry. Aluminum foil, 20 μm in thickness, was coated with the positive electrode slurry, dried and rolled to form the positive electrode. Crystal artificial graphite was used as the negative electrode active material and PVDF was used as a binder. After the crystal artificial graphite and the PVDF were mixed at a weight ratio of 92:8, the mixture was dispersed using N-methyl-2-pyrrolidone to form a negative electrode slurry. Copper foil, 15 μm in thickness, was coated with the negative electrode slurry, dried and rolled to form the negative electrode.

The film separator, 25 μm in thickness and composed of polyethylene (PE), was interposed between the electrodes as formed. The positive electrode, negative electrode and separator were wound and pressed together, and were put into a square can having the dimensions 30 mm×48 mm×6 mm.

An electrolyte was formed by adding 5.0 wt % fluoroethylene carbonate (FEC) to a solvent composed of ethylene carbonate/ethylmethyl carbonate/diethyl carbonate having a weight ratio of 1:1:1 and LiPF₆ at a density of 1.0 M. Then, 3 wt % 2-sulfobenzoic acid cyclic anhydride (SBACA) was added to the electrolyte. The lithium ion battery was manufactured by injecting the electrolyte into the square can.

### Exemplary Embodiment 6

Exemplary Embodiment 6 was carried out in the same manner as Exemplary Embodiment 5, except that fluoroethylene carbonate (FEC) was added in an amount of 10 wt % and 2-sulfobenzoic acid cyclic anhydride (SBACA) was added in an amount of 0.5 wt %.

### COMPARATIVE EXAMPLE 3

Comparative Example 3 was carried out in the same manner as Exemplary Embodiment 5, except that fluoroethylene carbonate (FEC) was not added.

### COMPARATIVE EXAMPLE 4

Comparative Example 4 was carried out in the same manner as Exemplary Embodiment 5, except that fluoroethylene carbonate (FEC) was added in an amount of 3 wt % and 2-sulfobenzoic acid cyclic anhydride (SBACA) was not added.

### COMPARATIVE EXAMPLE 5

Comparative Example 5 was carried out in the same manner as Exemplary Embodiment 5, except that fluoroethylene carbonate (FEC) was added in an amount of 15 wt % and 2-sulfobenzoic acid cyclic anhydride (SBACA) was added in an amount of 0.5 wt %.

After the lithium ion batteries of Exemplary Embodiments 5 and 6 and those of Comparative Examples 3 to 5 were charged under the conditions of CC-CV at a charging voltage of 4.2 V and at an electric current of 800 mA, the batteries were discharged at 2.75V cut-off and at an electric current of 800 mA. After this process was performed 300 times, the state of charge of each battery was measured and compared with initial capacity of the battery. The battery capacity after 300 cycles of charging/discharging was calculated as a percentage of the original charge.

Further, the low-temperature discharge capacity was measured by charging each of the lithium ion batteries of Exemplary Embodiments 5 and 6 and Comparative Examples 3 to 5 at 0.5 C at room temperature and by discharging each battery at 1 C at −20° C. Then, the low-temperature discharge capacity was calculated as a percentage of the discharge capacity at low temperature, based on the discharge capacity at room temperature.

Further, an increase rate in the thickness of each of the lithium ion batteries of Exemplary Embodiments 5 and 6 and Comparative Examples 3 to 5 was measured by charging each battery under the condition of CC-CV at a charging voltage of 4.2 V and at an electric current of 800 mA and thereafter by leaving each battery in a chamber at 60° C. for 10 days.

Table 2 shows the results of these measurements.

TABLE 2

| | FEC | SBACA | Capacity after | Discharge capacity | Increase rate in |
|---|---|---|---|---|---|
| | (wt %) | (wt %) | 300 cycles (%) | at −20° C. (%) | thickness (%) |
| Exemplary | 5 | 3 | 88 | 10 | 3.8 |
| Embodiment 5 | | | | | |
| Exemplary | 10 | 0.5 | 86 | 25 | 20 |
| Embodiment 6 | | | | | |
| Comparative | 0 | 3 | 68 | 0 | 4.1 |
| Example 3 | | | | | |
| Comparative | 3 | 0 | 75 | 20 | 18.0 |
| Example 4 | | | | | |
| Comparative | 15 | 0.5 | 86 | 20 | 35 |
| Example 5 | | | | | |

From the results shown in Table 2, the batteries of Exemplary Embodiments 5 and 6 displayed good characteristics with respect to the capacity after 300 charging/discharging cycles, the discharge capacity at −20° C. and the increase rate in the thickness of the battery being left in a chamber at 60° C. for 10 days. However, in the battery of Comparative Example 3, where FFC was not added, the capacity after 300 cycles was only 68% and the discharge capacity at −20° C. was 0%.

Further, in the battery of Comparative Example 4, where SBACA was not added, the capacity after 300 cycles was only 75%, indicating the life of the battery is not good, as can be shown by comparing the batteries of Table 1. Furthermore, in terms of the increase rate in the thickness of the battery that was left in a chamber at 60° C. for 10 days, the battery of Comparative Example 4 does not show any big difference compared with the battery of Exemplary Embodiment 6, where 0.5 wt % SBACA was added, but the battery of Exemplary Embodiment shows a very big difference compared with the battery of Exemplary Embodiment 5, where 3 wt % SBACA was added.

Further, in the battery of Comparative Example 5, where EFC was added in the amount of 15 wt %, that is, in an amount in excess of 10 wt %, the characteristics of the capacity after 300 cycles and the discharge capacity at −20° C. were good. However, when the battery was left in a chamber at 60° C. for 10 days, the increase rate in the thickness of the battery was very great.

Therefore, according to aspects of the present invention, the amount of 2-sulfobenzoic acid cyclic anhydride (SBACA) may be within the range of 0.1 to 5 wt % of the electrolyte and the amount of fluoroethylene carbonate (FEC) may be within the range of 0.1 to 10 wt % of the electrolyte, based on the measures of Tables 1 and 2 described above.

Next, the characteristics of batteries depending on whether 2-sulfobenzoic acid cyclic anhydride (SBACA) and fluoroethylene carbonate (FEC) are added will be compared below:

### COMPARATIVE EXAMPLE 6

Comparative Example 6 was carried out in the same manner as Exemplary Embodiment 1, except that fluoroethylene carbonate (FEC) was not added and 2-sulfobenzoic acid cyclic anhydride (SBACA) was added in an amount of 1 wt %.

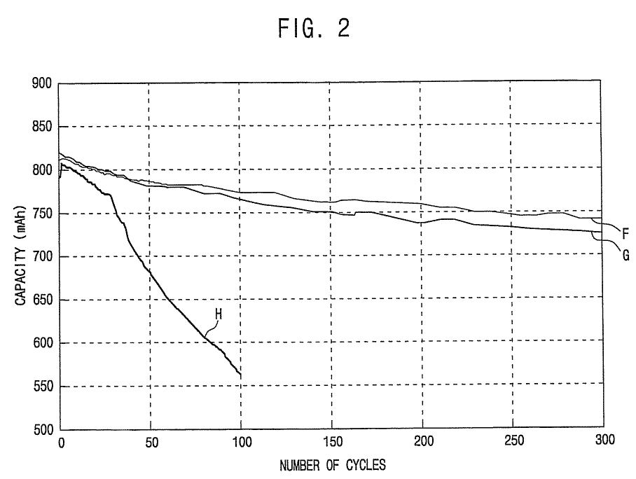

After the lithium ion batteries of Exemplary Embodiment 2 (3 wt % FEC and 1 wt % SBACA), Comparative Example 4 (3 wt % FEC) and Comparative Example 6 (1 wt % SBACA) were charged under the conditions of CC-CV at a charging voltage of 4.2 V and at an electric current of 800 mA, the batteries were discharged at 2.75V cut-off and at an electric current of 800 mA. After this process was performed 300 times, the capacity (mAh) of each battery was measured. The results of the measurement are shown in FIG. 2, which is a graph illustrating a change in capacity, depending on charging/discharging cycles.

With reference to FIG. 2, lines F, G and H indicate the capacity depending on the charging/discharging cycles of the batteries of Exemplary Embodiment 2 and Comparative Examples 4 and 6, respectively. In the battery of Exemplary Embodiment 2 where FEC and SBACA were both added as additives, the capacity after 100 cycles was 776 mAh and the capacity after 300 cycles was 742 mAh, indicating that the battery life is very excellent. However, in the battery of Comparative Example 4, where only FEC was added, the capacity after 100 cycles was 768 mAh and the capacity after 300 cycles was 725 mAh, indicating a decrease in the capacity maintenance rate, compared to the battery of Exemplary Embodiment 2. Further, in the battery of Comparative Example 6, where only SBACA was added, the capacity after 100 cycles remarkably decreased to 562 mAh.

That is, according to aspects of the present invention, it is noted that the characteristics of the battery in terms of the capacity maintenance rate are significantly improved where both 2-sulfobenzoic acid cyclic anhydride (SBACA) and fluoroethylene carbonate (FEC) are used, compared to where only 2-sulfobenzoic acid cyclic anhydride (SBACA) or only fluoroethylene carbonate (FEC) is used.

Therefore, in the lithium ion battery according to aspects of the present invention, in which 0.1 to 5 wt % 2-sulfobenzoic acid cyclic anhydride and 0.1 to 10 wt % fluoroethylene carbonate are added to the electrolyte, the thickness expansion of the battery decreases at room temperature and at high temperatures and the characteristics of the battery in terms of its life and low-temperature discharge capacity are excellent.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electrolyte for a lithium ion battery, comprising:
a non-aqueous organic solvent;
a lithium salt;
a first additive, which is 2-sulfobenzoic acid cyclic anhydride, represented by Formula 1 below, and
a second additive, which is a carbonate derivative having a substituent selected from the group consisting of halogen, a cyano (CN) group and a nitro (NO₂) group.

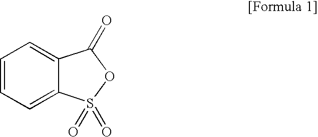

2. The electrolyte according to claim 1, wherein the amount of the first additive is 0.1 to 5 wt % of the electrolyte.

3. The electrolyte according to claim 1, wherein the amount of the second additive is 0.1 to 10 wt % of the electrolyte.

4. The electrolyte according to claim 1, wherein the second additive is an ethylene carbonate derivative represented by Formula 2 below, 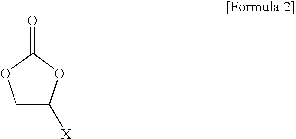
wherein X is selected from the group consisting of halogen, a cyano (CN) group and a nitro (NO₂) group.

5. The electrolyte according to claim 1, wherein the second additive is fluoroethylene carbonate.

6. The electrolyte according to claim 1, wherein the non-aqueous organic solvent comprises at least one selected from the group consisting of a carbonate, an ester, an ether and a ketone.

7. The electrolyte according to claim 6, wherein the carbonate is at least one selected from the group consisting of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC) and butylene carbonate (BC).

8. The electrolyte according to claim 1, wherein the lithium salt is at least one selected from the group consisting of LiPF₆, LiBF₄, LiSbF₆, LiAsF₆, LiClO₄, LiCF₃SO₃, LiN(CF₃SO₂)₂, LiN(C₂F₅SO₂)₂, LiAlO₄, LiAlCl₄, LiN(CₓF₂ₓ₊₁SO₂)(C_{y}F_{2y+1}SO₂), wherein, x and y are natural numbers, and LiSO₃CF₃.

9. A lithium secondary battery comprising:a positive electrode comprising a positive electrode active material that intercalates and deintercalates lithium ions; and
a negative electrode comprising a negative electrode active material that intercalates and deintercalates lithium ions, and
and electrolyte comprising:
a non-aqueous organic solvent,
a lithium salt,
a first additive, which is 2-sulfobenzoic acid cyclic anhydride, represented by Formula 1 below, and
a second additive, which is a carbonate derivative having a substituent selected from the group consisting of halogen, a cyano (CN) group and a nitro (NO₂) group.

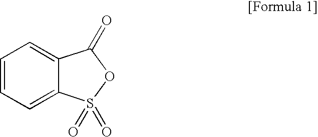

10. The lithium secondary battery according to claim 9, wherein the amount of the first additive is 0.1 to 5 wt % of the electrolyte.

11. The lithium secondary battery according to claim 9, wherein the amount of the second additive is 0.1 to 10 wt % of the electrolyte.

12. The lithium secondary battery according to claim 9, wherein the second additive is an ethylene carbonate derivative represented by Formula 2 below, 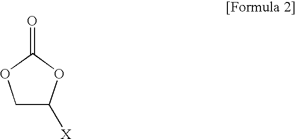
wherein X is selected from the group consisting of halogen, a cyano (CN) group and a nitro (NO₂) group.

13. The lithium secondary battery according to claim 9, wherein the second additive is fluoroethylene carbonate.

14. The lithium secondary battery according to claim 9, wherein the non-aqueous organic solvent is at least one selected from the group consisting of a carbonate, an ester, an ether and a ketone.

15. The lithium secondary battery according to claim 14, wherein the carbonate is at least one selected from the group consisting of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC) and butylene carbonate (BC).

16. The lithium secondary battery according to claim 9, wherein the lithium salt is at least one selected from the group consisting of LiPF₆, LiBF₄, LiSbF₆, LiAsF₆, LiClO₄, LiCF₃SO₃LiN(CF₃SO₂)₂, LiN(C₂F₅SO₂)₂, LiAlO₄, LiAlCl₄, LiN(CₓF₂ₓ₊₁SO₂)(C_{y}F_{2y+1}SO₂), wherein, x and y are natural numbers, and LiSO₃CF₃.

17. A method of inhibiting a breakdown of a solid electrolyte interface (SEI) film and a decomposition of a carbonate-based solvent of an electrolyte in a lithium secondary battery, the method comprising:
including, as additives in the electrolyte, 0.1 to 5 wt % of 2-sulfobenzoic acid cyclic anhydride and 0.1 to 10 wt % of a carbonate derivative having a substituent selected from the group consisting of halogen, a cyano (CN) group and a nitro (NO₂) group.

18. The method of claim 17, wherein the carbonate derivative is an ethylene carbonate derivative represented by Formula 2 below, 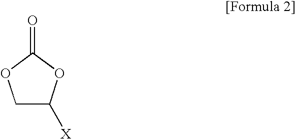
wherein X is selected from the group consisting of halogen, a cyano (CN) group and a nitro (NO₂) group.

19. The method of claim 18, wherein the second additive is fluoroethylene carbonate.
